(19) United States
(12) Patent Application Publication
(10) Pub. No.: US 2025/0204531 A1
(43) Pub. Date: Jun. 26, 2025

(54) AN AGROCHEMICAL COMPOSITION

(71) Applicant: UPL Limited, Mumbai (IN)

(72) Inventors: Rajan Ramakant SHIRSAT, Mumbai (IN); Ankush MALI, Mumbai (IN)

(21) Appl. No.: 18/849,159

(22) PCT Filed: Mar. 29, 2023
(86) PCT No.: PCT/IN2023/050303

§ 371 Date: Sep. 20, 2024

(30) Foreign Application Priority Data
Mar. 31, 2022 (IN) 202221019375

(51) Int. Cl. A01N 53/00; A01N 25/04; A01P 7/04

(52) U.S. Cl. CPC A01N 53/00; A01N 25/04; A01P 7/04

(57) ABSTRACT

The present invention relates to an agrochemical composition comprising an encapsulated active ingredient. The present invention more particularly relates to an agrochemical composition comprising an encapsulated active ingredient, wherein the encapsulation provides a controlled release of the active ingredient.

### FIELD OF THE INVENTION

The present invention relates to an agrochemical composition comprising an encapsulated active ingredient. The present invention more particularly relates to an agrochemical composition comprising an encapsulated active ingredient, wherein the encapsulation provides a controlled release of the active ingredient.

### BACKGROUND OF THE INVENTION

For many years, the main purpose of developing formulations was to facilitate the transport of the active ingredient to its target location, wherein the formulator faced issues with the physico-chemical properties of the formulation in bulk and when dispersed in a carrier medium, usually water. As an advancement to the various technologies available for formulation, controlled release techniques have been used to improve the efficacy of agrochemicals such as herbicides, insecticides, fertilizers, fungicides, bactericides, and the like.

One such advanced formulation technique is the encapsulation of the active ingredient. The encapsulation technique results in the release of active ingredients in a controlled manner over a long period. In this process, small particles or droplets of active ingredients are confined in a coating to form small capsules or microcapsules. The material inside the capsules forms the core and the outside coating becomes a barrier wall. Placing the active ingredient within a controlled release system helps to release the active ingredient slowly, thereby prolonging the effect of the treatment to the target area. Encapsulation of the active ingredient provides a possibility to obtain an efficient and economically beneficial pest management system. Among the innovative formulations available in the market, encapsulated agrochemicals offer a variety of desirable features that include reduction in human exposure to active ingredients, controlled release, longer residual concentrations, elimination of organic solvents, increased efficacy, etc.

Encapsulation technologies utilize a three-dimensional barrier that surround the active ingredients, shielding them from immediate interaction with their surrounding chemical environment.

Furthermore, an ideal pesticidal formulation is one which maintains an active ingredient level adequate for pest control, however leaving minimum residue in the environment and in the crop produce. Encapsulation of the active ingredient in a polymeric matrix can help achieve these goals. Polymer encapsulated formulations are superior to non-encapsulated commercial formulations in extending activity as well as reducing evaporative and degradation losses, leaching, and dermal toxicity. Also, in cases where the normal half-life of a potent pesticide is short, these encapsulated formulations are especially advantageous.

The materials used for encapsulation may be of natural, semi-synthetic and synthetic origin, and are selected according to the physical properties of the core and the intended application. The commonly used natural polymers are polysaccharides, cellulose, agarose, dextran, alginates, carrageenans, starch, chitosan and proteins including gelatin and albumin. The most frequently used synthetic polymers are polystyrene, polyacrylamide, polymethylacrylate, polyamides, polyesters, polyanhydrides, polyurea, polyurethanes, amino resins and polycyanoacrylates. Inorganic materials for microspheres include silica, zeolites, inorganic oxides, glass beads, and ceramics. Polyurea is generally used as a shell material in encapsulation because of its properties such as high stability and mechanical strength, low cost, and good release characteristics. Polyurea, which contains strong polar urea groups (—NHCONH—), can be synthesized from polyisocyanates and polyamines. The most widely used polyisocyanates are polyaryl polymethylene isocyanate, isophorone diisocyanate (IPDI), hexamethylene diisocyanate, methylene diphenyl diisocyanate (MDI), dicyclohexylmethane-4,40-diisocyanate, and toluene diisocyanate (TDI). Commonly used polyamines are ethylenediamine, hexanediamine, triethylenetetramine, and diethylenetriamine. However, polyamines have several disadvantages, when used as water-soluble reactants in microcapsule preparation, e.g., toxicity, volatility, and flammability, which result in long-lasting damages to the environment. Presently, there is an increasing interest in nontoxic biodegradable polymers such as amylose, cellulose, carboxymethyl cellulose, polylactic acid, polycaprolactone, etc. Therefore, the development of new, environmentally friendly surfactants is urgently needed from the point of view of environmental protection and sustainable development.

Furthermore, the dynamic surface tension (DST) allows comparing the surface tension as a function of time for the surfactants present in a polymer-surfactant composition. The DST is therefore controlled on one hand by the nature of the surfactant, for example, chain length, size, and charge of the polar head, and on the other hand by the nature of the liquid and the presence of other additives.

Therefore, there is an ongoing need to improve the activity of various kinds of agrochemically active ingredient formulations. Encapsulation seems to be one of the most prominent technologies that brings together many desirable advantages such as controlled release, protection of active ingredient from extrinsic factors, and providing a physical barrier against exposure leading to toxicity and contamination, as well as other advantages.

### Objectives of the Invention

A primary objective of the present invention is to provide an agrochemical composition comprising an encapsulated active ingredient.

Another objective of the present invention is to provide a stable agrochemical composition comprising an encapsulated active ingredient.

Yet another objective of the present invention is to provide a stable agrochemical composition comprising an encapsulated active ingredient facilitating controlled release of the active ingredient.

Another objective of the present invention is to provide a stable agrochemical composition with an optimum toxicity within the acceptable limits.

Yet another objective of the present invention is to provide a process of preparing a stable agrochemical composition comprising an encapsulated active ingredient.

Still another objective of the present invention is to provide a method of controlling pests using the stable agrochemical composition comprising an encapsulated active ingredient.

Yet another objective of the present invention is to provide a method of controlling weeds using the stable agrochemical composition comprising an encapsulated active ingredient.

### SUMMARY OF THE INVENTION

In one aspect of the present invention, an agrochemical composition comprises: at least one active ingredient; and an organic compound comprising a long aliphatic alkyl chain, encapsulating said active ingredient.

In another aspect of the present invention, an agrochemical composition comprises: at least one conditioned active ingredient; and an organic compound comprising a long aliphatic alkyl chain, encapsulating said active ingredient.

In another aspect of the present invention, an agrochemical composition comprises: at least one conditioned active ingredient; and an organic compound comprising a long aliphatic alkyl chain, encapsulating said active ingredient, wherein the active ingredient is conditioned by heating it to a temperature at or more than about 30° C.

In another aspect of the present invention, an agrochemical composition comprises:
at least one conditioned active ingredient; and
an organic compound comprising a long aliphatic alkyl chain, encapsulating said active ingredient,
wherein said organic compounds are epicuticular waxes (EW) of substituted long-chain aliphatic hydrocarbons comprising alkanes, alkyl esters, fatty acids, primary and secondary alcohols, diols, ketones, aldehydes or mixtures thereof; and wherein the active ingredient is conditioned by heating it to a temperature at or more than about 30° C.

In another aspect of the present invention, an agrochemical composition comprises:
at least one conditioned active ingredient;
at least one non-aqueous solvent;
an organic compound comprising a long aliphatic alkyl chain, encapsulating said active ingredient,
wherein the active ingredient is conditioned by heating it in the non-aqueous solvent to a temperature more than the softening point of the organic compound.

In another aspect of the present invention, a process for preparing an agrochemical composition comprises:
(a) conditioning an active ingredient by heating it at a temperature at or more than about 30° C.;
(b) admixing an organic compound comprising a long aliphatic alkyl chain with said active ingredient of step (a) to obtain a homogeneous mixture; and
(c) cooling the homogeneous mixture to room temperature to obtain the agrochemical composition.

In another aspect of the present invention, a process for preparing an agrochemical composition comprises:
(a) conditioning an active ingredient by adding it to a non-aqueous solvent and heating the temperature at or more than about 30° C.;
(b) admixing an organic compound comprising a long aliphatic alkyl chain with said active ingredient of step (a) to obtain a homogeneous mixture; and
(c) cooling the homogeneous mixture to room temperature to obtain the agrochemical composition.

In an aspect of the present invention, a method of controlling pests comprises applying to the pests or locus thereof, an agrochemical composition comprising at least one active ingredient; and an organic compound comprising a long aliphatic alkyl chain, encapsulating said active ingredient.

In another aspect of the present invention, a method of controlling weeds comprises applying to the weeds or locus thereof, an agrochemical composition comprising at least one active ingredient; and an organic compound comprising a long aliphatic alkyl chain, encapsulating said active ingredient.

In another aspect of the present invention, a method of controlling phytopathogenic fungal diseases comprises applying to the plants or locus thereof, an agrochemical composition comprising at least one active ingredient; and an organic compound comprising a long aliphatic alkyl chain, encapsulating said active ingredient.

### DETAILED DESCRIPTION OF THE INVENTION

### Source of Biological Material:

Carnauba Wax Used in the Present Invention has been Procured from Brazil. Carnauba wax also called Brazil wax and palm wax, is a wax of the leaves of the carnauba palm Copernicia prunifera, a plant native to and grown only in the north-eastern Brazilian states of Ceará, Piauí, Pernambuco, Rio Grande do Norte, Maranhão and Bahia.

The following description is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms used in the following description and claims are not limited to the bibliographical meanings but are merely used by the inventor to enable a clear and consistent understanding of the invention. Accordingly, it should be apparent to those skilled in the art that the following description of exemplary embodiments of the present disclosure are provided for illustration purpose only and not for limiting the scope of the invention as defined by the appended claims and their equivalents.

For the purposes of the present disclosure, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present disclosure in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term.

Prior to setting forth the present subject matter in detail, it may be helpful to provide definitions of certain terms used herein. Unless defined otherwise, all technical and scientific terms used herein have the same meaning as is commonly understood by one of skill in the art to which this subject matter pertains. The following definitions are provided for clarity.

The use of the terms “a” “an” and “the” and similar referents (especially in the context of the claims) are to be construed to cover both the singular and the plural, unless otherwise indicated herein or clearly contradicted by context. The terms first, second etc. as used herein are not meant to denote any particular ordering, but simply for convenience to denote a plurality of, for example, layers.

The terms “comprising”, “having”, “including”, and “containing” are to be construed as open-ended terms (i.e., meaning “including, but not limited to”) unless otherwise noted.

“About” or “approximately” as used herein is inclusive of the stated value and means within an acceptable range of deviation for particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.2%, 0.3%, etc. up to 80%.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

As used herein, the term “agrochemical” is understood to denote an agricultural chemical such as pesticides, fungicides, insecticides, acaricides, herbicides, nematicides, plant growth regulators and can be used interchangeably.

As used herein the term “plant” or “crop” refers to whole plants, plant organs (e.g., leaves, stems, twigs, roots, trunks, limbs, shoots, fruits etc.), plant cells, or plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “locus” as used herein denotes the vicinity or area designated for growth of a desired crop, and in which control of the growth and/or spread of undesirable vegetation or insect or fungi is desired. The locus includes the vicinity of desired crop plants wherein undesirable vegetation growth or fungal growth, or insect proliferation has either occurred, is most likely to occur, or is yet to occur.

As used herein references to “room temperature” means temperature in a range from about 20° C. to about 30° C.

The term “stable” as used herein refers to the chemical and/or physical stabilization of an active compound (e.g., insecticide, herbicide or fungicide) in terms of achieving chemical stability of the active ingredient and desired suspensibility and dispersibility of the composition by maintaining homogeneity of the components that impart shelf life up to 2 years, wherein the reduction in the concentration of the active content is not more than about 5%.

The “salts” referred to herein are agriculturally acceptable salts. As used herein, an “agriculturally acceptable salt” means a salt which is known and accepted for use in agricultural or horticultural use.

As used herein, the term “Dynamic Surface Tension (DST)” or “Interfacial Tension (IFT)” is the value of the DST or IFT referred to a particular surface age or interface age. The surface age is the period of time from the beginning of the creation of a surface or interface to the time of the observation or measurement. The time-dependent value is referred to as the Dynamic Surface Tension (DST). Dynamic Surface Tension (DST) is expressed as force per unit of width as millinewton per meter (mN/m). With respect to the present invention, dynamic surface tension is measured over a range from about 100 milliseconds (ms) to about 1000 milliseconds (ms).

As used herein, the term “surface age” and “bubble age” are used interchangeably.

As used herein, the term “contact angle” is defined as the angle where a liquid interacts with a solid surface. A high contact angle indicates that the surface has low wetting—that is, the liquid droplet will not spread very much onto the surface. A low contact angle indicates that the surface is high wetting, meaning that the liquid droplet spreads out more on the surface.

As used herein, the term “controlled release” is defined as slow release or quick release of the active ingredient over a period of time, in a controlled manner.

The inventors of the present invention found that an agrochemical composition comprising active ingredients being encapsulated by an organic compound having long aliphatic alkyl chain effectively controls the release of the active ingredient. Further, inventors of the present invention found that the active ingredients encapsulated by an organic compound having long aliphatic alkyl chain resulted in reduction of toxicity by preventing direct exposure of the active ingredients to humans and environment. The process of preparing said agrochemical composition involves heating the temperature of the active ingredient and optionally other excipients more than about 30° C. and contacting it with the organic compound comprising a long aliphatic alkyl chain to obtain a homogenous mixture and subsequently, allowing the mixture to cool down to the room temperature. The active ingredient is heated to a temperature at or more than about 30° C. such that it is more than the softening point of the organic compound comprising the long aliphatic alkyl chain. This process leads to encapsulation by way of matrix solidification in which the active ingredient is enclosed in the matrix provided by the organic compound. The inventors of the present invention further found that the agrochemical composition can be formulated as various formulation types providing a more versatile solution by keeping the active ingredient in the encapsulated form and facilitating controlled release in various forms such as capsule suspension, suspension concentrate, emulsion, water dispersible granules, wettable powders and the like.

As used herein, the term “conditioned active ingredient” means an active ingredient obtained by heating it to a temperature at or more than about 30° C., either directly or after mixing it in solvent.

As used herein, the term “softening point” of an organic compound comprising a long aliphatic alkyl chain means the temperature at which said organic compound undergoes molecular re-arrangement and starts to lose its crystallinity under the influence of heat.

According to an embodiment of the present invention, an agrochemical composition comprises:
at least one active ingredient; and
an organic compound comprising a long aliphatic alkyl chain, encapsulating said active ingredient.

According to an embodiment of the present invention, the active ingredient is an agrochemical.

According to an embodiment of the present invention, the active ingredient is an agrochemical selected from the group comprising pesticides, herbicides, insecticides, acaricides, nematicides, fungicides, molluscicides, plant growth regulators, safeners, algicides, avicides/bird repellents, bactericides, insect attractants (semiochemicals), insect chemosterilants, insect repellents, mammal repellents, nitrification inhibitors, plant activators, rodenticides, synergists, virucides, and mixtures thereof.

In a preferred embodiment, the active ingredient is selected from the group comprising herbicides, insecticides, fungicides, biological agents and biostimulants, and mixtures thereof.

According to an embodiment of the present invention, the herbicide is selected from the group comprising aliphatic acid herbicides, amide herbicides, aromatic acid herbicides, benzofuran herbicides, benzonitrile herbicides, benzophenone herbicides, benzothiadiazinone herbicides, benzyl ether herbicides, botanical herbicides, carbamate herbicides, cyclohexanedione oxime herbicides, dinitroaniline herbicides, dinitrophenol herbicides, diphenyl ether herbicides, diphenyl heterocyle herbicides, dithiocarbamate herbicides, fumigant herbicides, halogenated alkanoic acid herbicides, imidazolinone herbicides, inorganic herbicides, isoxazole herbicides, isoxazolidinone herbicides, isoxazoline herbicides, N-phenyl heterocycle herbicides, N-phenylimide herbicides, N-phenyloxadiazolone herbicides, N-phenyltriazolinone herbicides, organochlorine herbicides, organophosphorous herbicides, oxirane herbicides, oxyacetamide herbicides, phenol herbicides, phenoxy herbicides, phenylcarboxylic acid herbicides, phenyl ether herbicides, phenylthiourea herbicides, pyrazole herbicides, pyridazine herbicides, pyridazinone herbicides, pyridine herbicides, pyrimidinediamine herbicides, pyrimidinyloxybenzylamine herbicides, quaternary ammonium herbicides, quinone herbicides, alpha-thioacetamide herbicides, thiocarbamate herbicides, thiocarbonate herbicides, triazine herbicides, triazinone herbicides, triazole herbicides, triazolone herbicides, triazolopyrimidine herbicides, triketone herbicides, uracil herbicides, urea herbicides, unclassified herbicides, and combinations thereof.

According to an embodiment of the present invention, the herbicide is selected from the group comprising 2,4-D, bensulfuron-methyl, bentazone, butachlor, carfentrazone, amicarbazone, sulfentrazone, cyhalofop-butyl, haloxyfop-p-methyl, clodinafop-propargyl, clethodim, imazosulfuron, 2-methyl-4-chlorophenoxyacetic acid (MCPA), mefenacet, napropamide, glufosinate, clomazone, oxadiazon, pendimethalin, pretilachlor, pyrazosulfuron-ethyl, metsulfuron, their derivatives, and mixtures thereof.

According to an embodiment of the present invention, the insecticide is selected from the group comprising alkyl halide insecticides, aminopyrimidine insecticides, aminotriazene insecticides, antibiotic insecticides, aromatic hydrocarbon insecticides, arylpyrrole insecticides, benzimidazole insecticides, benzoylurea insecticides, beta-ketonitrile insecticides, botanical insecticides, carbamate insecticides, diacylhydrazine insecticides, diamide insecticides, dinitrophenol insecticides, dithiolane insecticides, formamidine insecticides, fumigant insecticides, inorganic insecticides, isoxazoline insecticides, juvenile hormone mimics, juvenile hormones, macrocyclic lactone insecticides, meta-diamide insecticides, methoxyacrylate insecticides, neonicotinoid insecticides, nereistoxin analogue insecticides, organochlorine insecticides, organophosphorus insecticides, oxadiazine insecticides, oxadiazolone insecticides, perfluoroalkyl sulfonamide insecticides, phenol insecticides, precocenes, pyrazole insecticides, pyrethrin insecticides, pyrethroid insecticides, pyridine azomethine insecticides, pyrimidinamine insecticides, pyropene insecticides, RNA1 insecticides, salicylanilide insecticides, semicarbazone insecticides, steroid insecticides, tetramic acid insecticides, tetronic acid insecticides, thiocarbonate insecticides, thiourea insecticides, urea insecticides, unclassified insecticides, and combinations thereof.

According to an embodiment of the present invention, the insecticide is selected from the group comprising acephate, cypermethrin, bifenthrin, lambda-cyhalothrin, cyhalothrin, buprofezin, carbofuran, cartap, chlorfenapyr, chlorpyrifos, dimethoate, malathion, imidacloprid, acetamiprid, clothianidin, monocrotophos, nitenpyram, pirimiphos, propoxur, thiodicarb, trichlorphon, chlorantraniliprole, cyantraniliprole their derivatives and mixtures thereof.

In an embodiment, the insecticide is lambda-cyhalothrin.

In an embodiment, the insecticide is cyhalothrin.

In an embodiment, the insecticide is bifenthrin.

According to an embodiment of the present invention, the fungicide is selected from the group comprising aliphatic nitrogen fungicides, alkyltriazole fungicides, amide fungicides, amidine fungicides, aminocyanoacrylate fungicides, aminopyrazolinone fungicides, antibiotic fungicides, aromatic fungicides, arylphenyl ketone fungicides, azole fungicides, benzimidazole fungicides, benzoisothiazole fungicides, benzothiadiazole fungicides, benzothiazole fungicides, benzotriazine fungicides, botanical fungicides, butyrolactone fungicides, carbamate fungicides, chloronitrile fungicides, cyanoimidazole fungicides, dicarboximide fungicides, dinitroaniline fungicides, dinitrophenol fungicides, dithiocarbamate fungicides, dithiolane fungicides, formamide fungicides, fumigant fungicides, guanidine fungicides, hydrazide fungicide, imidazoline fungicides, imidazolinone fungicides, inorganic fungicides, isobenzofuranone fungicides, isothiazole fungicides, isothiazolone fungicides, isoxazole fungicides, morpholine fungicides, nitrobenzene fungicide, organochlorine fungicides, organophosphorus fungicide, oxazole fungicides, oxazolidinedione fungicides, oxazolidinone fungicides, phenol fungicides, phenylpropanol fungicides, phenylpyrrole fungicides, phenylurea fungicides, phthalamic acid fungicides, piperazine fungicides, piperidine fungicides, piperidinyl-thiazole-isoxazoline fungicides, polyoxin fungicides, polysulfide fungicides, pyridazine fungicides, pyridazinone fungicides, pyridine fungicides, pyrimidine fungicides, pyrroloquinolinone fungicides, quaternary ammonium fungicides, quinazoline fungicides, quinazolinone fungicides, quinoline fungicides, quinolyl acetate fungicides, quinone fungicides, quinoxaline fungicides, spiroketalamine fungicides, strobilurin fungicides, sulfamoyltriazole fungicides, tetrazolinone fungicides, tetrazolyloxime fungicides, 1,2,4-thiadiazole fungicides, 1,3,4-thiadiazole fungicides, thiazolidine fungicides, thiocarbamate fungicides, thiocarbonate fungicides, thiophene fungicides, thiophanate fungicides, 1,3,5-triazine fungicides, triazolobenzothiazole fungicides, triazolopyrimidine fungicides, unclassified fungicides, and combinations thereof.

According to an embodiment of the present invention, the fungicide is selected from the group comprising boscalid, tebuconazole, azoxystrobin, fluoxastrobin, prothioconazole, cyproconazole, trifloxystrobin, captan, folpet, kasugamycin, metalaxyl, thiophanate-methyl, tricyclazole, triflumizole, and validamycin, copper fungicides, mancozeb, mancopper, zineb, fluindapyr, bixafen, fluxapyroxad their derivatives and mixtures thereof.

According to an embodiment, the biological agents and biostimulants are selected from the group comprising seaweed extract, laminarin, essential oils, superabsorbent polymers, ortho-silicic acid, ancymidol, butralin, alcohols, chlormequat chloride, cytokinin, daminozide, ethephon, ethylene, humic acid, fulvic acid, flurprimidol, gibberellic acid, gibberellin mixtures, indole-3-butyric acid (IBA), maleic hydrazide, potassium salt, mefluidide, mepiquat chloride, mepiquat pentaborate, naphthalene-acetic acid (NAA), 1-naphthaleneacetamide (NAD), n-decanol, paclobutrazol, prohexadione calcium, trinexapac-ethyl, uniconazole, and combinations thereof.

According to an embodiment of the present invention, the active ingredient is a solid at room temperature.

According to an embodiment of the present invention, the active ingredient is a liquid at room temperature.

According to an embodiment of the present invention, the agrochemical composition comprises from about 0.1% w/w to about 99% w/w, and preferably from about 0.5% w/w to about 90% w/w active ingredient of total weight of the agrochemical composition.

According to an embodiment of the present invention, the agrochemical composition comprises from about 0.1% w/w to about 99% w/w, and preferably from about 0.5% w/w to about 90% w/w lambda-cyhalothrin of total weight of the agrochemical composition.

In a preferred embodiment, the agrochemical composition comprises of about 50% w/w lambda-cyhalothrin of total weight of the agrochemical composition.

In a preferred embodiment, the agrochemical composition comprises of about 25% w/w lambda-cyhalothrin of total weight of the agrochemical composition.

In a preferred embodiment, the agrochemical composition comprises of about 24.47% w/w lambda-cyhalothrin of total weight of the agrochemical composition.

In a preferred embodiment, the agrochemical composition comprises of about 24.23% w/w lambda-cyhalothrin of total weight of the agrochemical composition.

In a preferred embodiment, the agrochemical composition comprises of about 10% w/w lambda-cyhalothrin of total weight of the agrochemical composition.

According to an embodiment of the present invention, the agrochemical composition comprises from about 0.1% w/w to about 99% w/w, and preferably from about 0.5% w/w to about 90% w/w cyhalothrin of total weight of the agrochemical composition.

According to an embodiment of the present invention, the agrochemical composition comprises from about 0.1% w/w to about 99% w/w, and preferably from about 0.5% w/w to about 90% w/w bifenthrin of total weight of the agrochemical composition.

In a preferred embodiment, the agrochemical composition comprises of about 50% w/w bifenthrin of total weight of the agrochemical composition.

In a preferred embodiment, the agrochemical composition comprises of about 10% w/w bifenthrin of total weight of the agrochemical composition.

According to an embodiment of the present invention, the agrochemical composition comprises an organic compound comprising a long aliphatic alkyl chain.

According to an embodiment of the present invention, the organic compound comprises a long aliphatic alkyl chain that are mixtures of substituted long-chain aliphatic hydrocarbons, comprising alkanes, alkyl esters, fatty acids, primary and secondary alcohols, diols, ketones and aldehydes, and mixtures thereof.

According to an embodiment of the present invention, the organic compound comprising a long aliphatic alkyl chain is selected from the group comprising hydrogenated and unhydrogenated fats.

According to an embodiment of the present invention, the organic compound comprises a triglyceride or a fatty acid.

According to an embodiment of the present invention, the organic compound is a wax.

According to an embodiment of the present invention, the organic compound is a plant wax.

According to an embodiment of the present invention, the organic compound is a plant wax, selected from the group comprising cotton wax, carnauba wax, rice bran wax, candelilla wax, Japan wax, sugarcane wax, and mixtures thereof.

In a preferred embodiment, the organic compound is carnauba wax.

According to an embodiment of the present invention, the organic compound comprises epicuticular waxes (EW) of plants that are mixtures of substituted long-chain aliphatic hydrocarbons, comprising alkanes, alkyl esters, fatty acids, primary and secondary alcohols, diols, ketones and aldehydes, and mixtures thereof.

According to an embodiment of the present invention, the organic compound is a carnauba wax comprising fatty acid esters (80-85%), fatty alcohols (10-16%), acids (3-6%) and hydrocarbons (1-3%). It is around 20% esterified fatty diols, 10% methoxylated or hydroxylated cinnamic acid, and 6% hydroxylated fatty acids.

According to an embodiment of the present invention, the organic compound is an animal wax.

According to an embodiment of the present invention, the organic compound is an animal wax comprising esters derived from a variety of fatty acids and carboxylic alcohols.

According to an embodiment of the present invention, the organic compound is an animal wax selected from the group comprising beeswax, wool wax, shellac wax, and mixtures thereof.

According to an embodiment of the present invention, the organic compound is a mineral wax.

According to an embodiment of the present invention, the organic compound is a mineral wax selected from the group comprising ceresin, ozokerite, Montan wax, and mixtures thereof.

According to an embodiment of the present invention, the organic compound is a chemically modified wax.

According to an embodiment of the present invention, the organic compound is a chemically modified wax selected from the group comprising hydrogenated jojoba waxes, Montan ester wax, polyalkylene waxes, polyethylene glycol waxes, amide waxes and Fischer-Tropsch paraffin waxes.

According to an embodiment of the present invention, the agrochemical composition comprises from about 0.1% w/w to about 99% w/w, and preferably from about 0.5% w/w to about 90% w/w organic compound of total weight of the agrochemical composition.

According to an embodiment of the present invention, the agrochemical composition comprises from about 0.1% w/w to about 99% w/w, and preferably from about 0.5% w/w to about 90% w/w carnauba wax of total weight of the agrochemical composition.

In a preferred embodiment, the agrochemical composition comprises of about 50% w/w carnauba wax of total weight of the agrochemical composition.

In a preferred embodiment, the agrochemical composition comprises of about 6% w/w carnauba wax of total weight of the agrochemical composition.

In a preferred embodiment, the agrochemical composition comprises of about 4.0% w/w carnauba wax of total weight of the agrochemical composition.

In a preferred embodiment, the agrochemical composition comprises of about 0.20% w/w carnauba wax of total weight of the agrochemical composition.

In a preferred embodiment, the agrochemical composition comprises of about 0.10% w/w carnauba wax of total weight of the agrochemical composition.

According to an embodiment of the present invention, the organic compound has a melting point at a temperature ranging from about 35° C. to about 160°.

According to an embodiment of the present invention, the organic compound has a softening point at a temperature ranging from about 35° C. to about 80° C.

According to an embodiment of the present invention, the organic compound has a softening point at a temperature ranging from about 40° C. to about 65° C.

According to an embodiment of the present invention, an agrochemical composition comprises:
at least one active ingredient; and
an organic compound comprising a long aliphatic alkyl chain, encapsulating said active ingredient;
wherein said active ingredient and said organic compound are in a weight ratio from about 1:100 to about 100:1.

According to an embodiment, the weight ratio of the active ingredient to the organic compound is selected from ratios comprising 1:1, 1:10, 1:20, 1:30, 1:40, 1:50, 1:60, 1:70, 1:80, 1:90, and 1:100.

According to an embodiment, the weight ratio of the active ingredient to the organic compound is selected from ratios comprising 100:1, 90:1, 80:1, 70:1, 60:1, 50:1, 40:1, 30:1, 20:1, 10:1, and 1:1.

According to an embodiment of the present invention, the active ingredient and the organic compound comprising a long aliphatic alkyl chain are in a weight ratio of about 1:80.

According to an embodiment of the present invention, the active ingredient and the organic compound comprising a long aliphatic alkyl chain are in a weight ratio of about 1:60.

According to an embodiment of the present invention, the active ingredient and the organic compound comprising a long aliphatic alkyl chain are in a weight ratio of about 1:40.

According to an embodiment of the present invention, the active ingredient and the organic compound comprising a long aliphatic alkyl chain are in a weight ratio of about 1:20.

According to an embodiment of the present invention, the active ingredient and the organic compound comprising a long aliphatic alkyl chain are in a weight ratio of about 80:1.

According to an embodiment of the present invention, the active ingredient and the organic compound comprising a long aliphatic alkyl chain are in a weight ratio of about 60:1.

According to an embodiment of the present invention, the active ingredient and the organic compound comprising a long aliphatic alkyl chain are in a weight ratio of about 40:1.

According to an embodiment of the present invention, the active ingredient and the organic compound comprising a long aliphatic alkyl chain are in a weight ratio of about 20:1.

According to an embodiment of the present invention, the active ingredient and the organic compound comprising a long aliphatic alkyl chain are in a weight ratio of about 10:1.

According to an embodiment of the present invention, the active ingredient and the organic compound comprising a long aliphatic alkyl chain are in a weight ratio of about 1:1.

According to an embodiment of the present invention, an agrochemical composition comprises:
at least one conditioned active ingredient; and
an organic compound comprising a long aliphatic alkyl chain, encapsulating said active ingredient.

According to an embodiment of the present invention, the active ingredient is conditioned by heating it to a temperature at or more than about 30° C.

According to an embodiment of the present invention, the active ingredient is conditioned by heating it to a temperature ranging from about 40° C. to about 140° C.

According to an embodiment of the present invention, the active ingredient is conditioned by heating it to a temperature ranging from about 80° C. to about 95° C.

According to an embodiment of the present invention, the active ingredient is conditioned by heating it to a temperature such that it surpasses the softening point of an organic compound comprising a long aliphatic alkyl chain.

According to an embodiment of the present invention, the active ingredient is conditioned by mixing it in a solvent and then heating the resultant mixture to a temperature at or more than about 30° C.

According to an embodiment of the present invention, the active ingredient is conditioned by mixing it in a solvent and then heating the resultant mixture to a temperature more than about 30° C.

According to an embodiment of the present invention, the active ingredient is conditioned by mixing it in a solvent and then heating the resultant mixture to a temperature more than about 40° C. to about 140° C.

According to an embodiment of the present invention, the active ingredient is conditioned by mixing it in a solvent and then heating the mixture to a temperature more than about 80° C. to about 95° C.

According to an embodiment of the present invention, an agrochemical composition comprises:
at least one active ingredient;
at least one non-aqueous solvent; and
an organic compound comprising a long aliphatic alkyl chain, encapsulating said active ingredient,
wherein the active ingredient is conditioned by heating it in the non-aqueous solvent to a temperature of more than the softening point of the organic compound.

According to an embodiment of the present invention, an agrochemical composition comprises:
at least one conditioned active ingredient;
at least one non-aqueous solvent selected from the group comprising aromatic or aliphatic hydrocarbons, alcohols, ketones, esters, ether, amides, derivatives, and mixtures thereof; and
an organic compound comprising a long aliphatic alkyl chain, encapsulating said active ingredient,
wherein the active ingredient is conditioned by heating it in the non-aqueous solvent to a temperature at the softening point of the organic compound.

According to an embodiment of the present invention, an agrochemical composition comprises:
at least one conditioned active ingredient;
at least one non-aqueous solvent selected from the group comprising aromatic or aliphatic hydrocarbons, alcohols, ketones, esters, ether, amides, derivatives, and mixtures thereof;
an organic compound comprising a long aliphatic alkyl chain, encapsulating said active ingredient, and
wherein the active ingredient is conditioned by heating it in the non-aqueous solvent to a temperature of more than the softening point of the organic compound.

According to an embodiment of the present invention, the active ingredient is conditioned by mixing it in a non-aqueous solvent and then heating the mixture to a temperature of more than about 80° C. to about 95° C.

According to an embodiment of the present invention, an agrochemical composition comprises:
conditioned lambda-cyhalothrin;
an aromatic hydrocarbon solvent; and
carnauba wax;
wherein lambda-cyhalothrin is conditioned by heating it in the aromatic hydrocarbon solvent to a temperature more than the softening point of the carnauba wax.

According to an embodiment of the present invention, an agrochemical composition comprises:
lambda-cyhalothrin;
an aromatic hydrocarbon solvent; and
carnauba wax encapsulating lambda-cyhalothrin;
wherein lambda-cyhalothrin is conditioned by heating it in the aromatic hydrocarbon solvent to a temperature more than the softening point of the carnauba wax.

According to an embodiment of the present invention, an agrochemical composition comprises:
conditioned bifenthrin;
an aromatic hydrocarbon solvent; and
carnauba wax;
wherein bifenthrin is conditioned by heating it in the aromatic hydrocarbon solvent to a temperature more than the softening point of carnauba wax.

According to an embodiment of the present invention, an agrochemical composition comprises:
bifenthrin;
an aromatic hydrocarbon solvent; and
carnauba wax encapsulating bifenthrin;
wherein bifenthrin is conditioned by heating it in the aromatic hydrocarbon solvent to a temperature more than the softening point of the carnauba wax.

According to an embodiment of the present invention, an agrochemical composition comprises:
at least one conditioned active ingredient;
an aromatic hydrocarbon solvent;
carnauba wax; and
optionally an agrochemically acceptable excipient, wherein the active ingredient is conditioned by heating it in the aromatic hydrocarbon to a temperature of more than the softening point of carnauba wax.

According to an embodiment of the present invention, an agrochemical composition comprises:
at least one conditioned active ingredient;
an aromatic hydrocarbon solvent;
carnauba wax; and
an agrochemically acceptable excipient,
wherein the active ingredient is conditioned by heating it in the aromatic hydrocarbon to a temperature of more than the softening point of carnauba wax.

According to an embodiment of the present invention, the agrochemically active ingredient is conditioned by mixing it in the aromatic hydrocarbon solvent and then heating the mixture to a temperature of more than about 80° C. to about 95° C.

In an embodiment, the aromatic hydrocarbon solvent is selected from the group comprising of benzene, toluene, xylene, high solvency C9 aromatic fluid), high solvency C10 aromatic fluid, high solvency naphthalene depleted C10 aromatic fluid, high solvency C11 aromatic fluid, and mixtures thereof.

According to an embodiment of the present invention, the agrochemical composition comprises from about 0.1% w/w to about 90% w/w aromatic hydrocarbon solvent, and preferably from about 1% w/w to about 85% w/w aromatic hydrocarbon solvent of total weight of the composition.

In a preferred embodiment, the agrochemical composition comprises of about 81.80% w/w aromatic hydrocarbon solvent of total weight of the agrochemical composition.

In a preferred embodiment, the agrochemical composition comprises of about 10% w/w aromatic hydrocarbon solvent of total weight of the agrochemical composition.

In a preferred embodiment, the agrochemical composition comprises of about 4.0% w/w aromatic hydrocarbon solvent of total weight of the agrochemical composition.

According to an embodiment of the present invention, the agrochemical composition comprises from about 0.1% w/w to about 90% w/w active ingredient; and from about 0.1% w/w to about 60% w/w organic compound comprising a long aliphatic alkyl chain of total weight of the agrochemical composition.

According to an embodiment of the present invention, the agrochemical composition comprises from about 10% w/w to about 60% w/w active ingredient;

and from about 10% w/w to about 60% w/w organic compound comprising a long aliphatic alkyl chain of total weight of the agrochemical composition.

According to an embodiment of the present invention, an agrochemical composition comprises:
at least one conditioned active ingredient; and
an organic compound comprising a long aliphatic alkyl chain, encapsulating said active ingredient,
wherein said organic compounds are epicuticular waxes of substituted long-chain aliphatic hydrocarbons comprising alkanes, alkyl esters, fatty acids, primary and secondary alcohols, diols, ketones, aldehydes, and mixtures thereof; and wherein said active ingredient is conditioned by heating it to a temperature of more than about 30° C.

According to an embodiment of the present invention, an agrochemical composition comprises:
at least one conditioned active ingredient;
an organic compound comprising a long aliphatic alkyl chain, encapsulating said active ingredient;
wherein said organic compound is an animal wax comprising esters derived from a variety of fatty acids and carboxylic alcohols; and
wherein said active ingredient is conditioned by heating it to a temperature of more than about 30° C.

According to an embodiment, the surface tension of the agrochemical composition is present in a range from about 30 N/m to 70 N/m.

In a preferred embodiment, the surface tension of the agrochemical composition is present in a range from about 40 N/m to about 60 N/m.

According to an embodiment, the contact angle of the agrochemical composition is present in a range from about 65° to about 90°.

In a preferred embodiment, the contact angle of the agrochemical composition is present in a range from about 70° to about 85°.

According to an embodiment, from about 70% to about 80% active ingredient releases in from about 25 minutes to about 35 minutes; and remaining from about 20% to about 30% active ingredient releases in next about 30 minutes.

According to an embodiment of the present invention, the agrochemical composition further comprises at least one agrochemically acceptable excipients selected from the group comprising surfactant(s), thickener(s)/binder(s)/binding agent(s), disintegrant(s), lubricant(s), wetting agent(s), dispersing agent(s), anti-freezing agent(s), minerals(s), fillers(s), colorant(s), biocide(s), pH adjuster(s), solvent(s), antioxidant(s) and the like.

In an embodiment, the surfactant(s) may include any or a combination of ionic surfactants and non-ionic surfactants. Non-limiting examples of ionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates. Non-limiting examples of the non-ionic surfactants include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof. Also included are EO/PO block copolymers (EO is ethylene oxide, PO is propylene oxide), EO polymers and copolymers, polyamines, and polyvinylpynolidones, sorbitan fatty acid alcohol ethoxylates and sorbitan fatty acid ester ethoxylates.

In an embodiment, the thickener(s)/binder(s) comprise lactose powder, dibasic calcium phosphate, sucrose, corn (maize) starch, microcrystalline cellulose or modified cellulose, like for example hydroxymethyl cellulose. The binding agent may include any or a combination of polyvinyl alcohols, phenyl naphthalene sulphonate, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymer, propylene oxide copolymer, polyethylene glycols and polyethylene oxides, but not limited thereto.

In another embodiment, the agrochemical composition may also contain an ingredient that can act as a disintegrant(s), which hydrates readily in water and thereby improves the dispersion of the composition in water. Some of the aforementioned binders, like for example starch and cellulose, can also be used as a disintegrant.

In another embodiment, the commonly used lubricant(s) are for example magnesium stearate, stearic acid (stearine), hydrogenated oil and sodium stearyl fumarate.

In another embodiment, the wetting agent(s) may include any or a combination of sulfosuccinates, naphthalene sulfonates, sulfated esters, phosphate esters, sulfated alcohol and alkyl benzene sulfonates, but not limited thereto.

In another embodiment, the dispersing agent(s) may include any or a combination of polycarboxylates, naphthalene sulfonate condensates, phenol sulfonic acid condensates, lignosulfonates, methyl oleyl taurates and polyvinyl alcohols, but not limited thereto.

In an embodiment, the anti-freezing agent(s) may include any or a combination of ethylene glycol, propylene glycol, urea, glycerin and anti-freeze proteins, but not limited thereto.

In an embodiment, the mineral(s) may include any or a combination of kaolin, silica, titanium (IV) oxide, rutile, anatase, aluminum oxides, aluminum hydroxides, iron oxide, iron sulfide, magnetite, pyrite, hematite, ferrite, gregite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, copper, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, and indium tin oxide, but not limited thereto.

In an embodiment, the filler(s) may include any or a combination of diatomaceous earth, kaolin, bentonite, precipitated silica, attapulgite, and perlite, but not limited thereto.

In an embodiment, colorant(s) may be selected from iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum and zinc.

According to an embodiment, biocide(s) may be selected from benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl.

In an embodiment, the present composition further comprises at least one buffering agent acting as a pH adjuster(s) to maintain the pH of the composition.

According to an embodiment, examples of suitable solvent(s) are water, aromatic solvents (for example, xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones (NMP, NEP, NOP), acetates (glycol diacetate), glycols, fatty acid dimethylamides, fatty acids and fatty acid esters, isophorone and dimethylsulfoxide. In principle, solvent mixtures may also be used.

The agrochemical composition may also comprise one or more antioxidant(s). Preferably, the agrochemical formulation comprises an antioxidant. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., a-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, y-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., a-hydroxy fatty acids, EDTA, EGTA, phytic acid, lactoferrin), a-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., y-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to the disclosure, suitable derivatives (salts, esters, sugars, nucleotides, nucleosides, peptides, and lipids) and mixtures of these specified active ingredients or plant extracts (e.g., teatree oil, rosemary extract and rosemarinic acid) which comprise these antioxidants can be used. In general, mixtures of the aforementioned antioxidants are possible.

According to an embodiment, the agrochemically acceptable excipients are present in an amount ranging from about 1% w/w to about 99% w/w of total weight of the composition.

According to an embodiment, the agrochemically acceptable excipients are present in an amount ranging from about 1% w/w to about 70% w/w of total weight of the composition.

According to an embodiment of the present invention, the agrochemical composition can be formulated in a form of water dispersible granules (WDG or WG), capsule suspension (CS), suspension concentrate (SC), emulsion, microemulsion (ME), emulsifiable concentrate (EC), oil dispersion (OD), wettable powder (WP), granules (GR), extended-release granules, sustained release granules, delayed release granules, controlled release granules, ZC (mixed formulation of CS and SC), dry powder, and the like.

In a preferred embodiment, the agrochemical composition is present in a form of capsule suspension (CS), dry powder, emulsifiable concentrate (EC), and combinations thereof.

In another embodiment, the agrochemical composition is present in a form of capsule suspension (CS).

In another embodiment, the agrochemical composition is present in a form of dry powder.

In another embodiment, the agrochemical composition is present in a form of emulsifiable concentrate (EC).

According to an embodiment, the capsule suspension (CS) composition comprises: at least one active ingredient; and an organic compound comprising a long aliphatic alkyl chain, encapsulating said active ingredient.

According to an embodiment, the capsule suspension (CS) composition comprises: at least one active ingredient;
an aromatic hydrocarbon solvent; and
an organic compound comprising a long aliphatic alkyl chain, encapsulating said active ingredient.

According to an embodiment, the dry powder composition comprises:
at least one active ingredient; and
an organic compound comprising a long aliphatic alkyl chain, encapsulating said active ingredient.

According to an embodiment, the dry powder composition comprises:
at least one active ingredient;
an aromatic hydrocarbon solvent; and
an organic compound comprising a long aliphatic alkyl chain, encapsulating said active ingredient.

According to an embodiment, the emulsifiable concentrate (EC) composition comprises:
at least one active ingredient; and
an organic compound comprising a long aliphatic alkyl chain, encapsulating said active ingredient.

According to an embodiment, the emulsifiable concentrate (EC) composition comprises:
at least one active ingredient;
an aromatic hydrocarbon solvent; and
an organic compound comprising a long aliphatic alkyl chain, encapsulating said active ingredient.

In an embodiment, the agrochemical composition further comprises at least one from the group of fertilizers, mycorrhiza, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents, and mixtures thereof.

According to an embodiment of the present invention, a process for the preparation of an agrochemical composition, wherein said process comprises:
(a) conditioning at least one active ingredient by heating it at a temperature more than about 30° C.;
(b) admixing an organic compound comprising a long aliphatic alkyl chain with the active ingredient of step (a) to obtain a homogeneous mixture; and
(c) cooling the homogeneous mixture to room temperature to obtain the agrochemical composition.

According to an embodiment of the present invention, a process for the preparation of an agrochemical composition involves conditioning of at least one active ingredient by heating to a temperature of more than the softening point of the active ingredient and admixing the organic compound comprising a long aliphatic alkyl chain at a temperature of more than the softening point of the active ingredient.

According to an embodiment of the present invention, a process for the preparation of an agrochemical composition; wherein said process comprises:
(a) conditioning at least one active ingredient by heating the temperature at or more than about 30° C.;
(b) admixing the organic compound comprising the long aliphatic alkyl chain with said active ingredient of step (a) to obtain a homogeneous mixture, wherein said organic compound is carnauba wax; and
(c) cooling the homogeneous mixture to room temperature to obtain the agrochemical composition.

According to an embodiment of the present invention, a process for the preparation of an agrochemical composition; wherein said process comprises:
(a) conditioning at least one active ingredient by heating the temperature of more than about 30° C.;
(b) admixing the organic compound comprising the long aliphatic alkyl chain with said active ingredient of step (a) to obtain a homogeneous mixture, wherein said organic compound is carnauba wax; and
(c) cooling the homogeneous mixture to room temperature to obtain the agrochemical composition.

According to an embodiment of the present invention, a process for the preparation of an agrochemical composition; wherein said process comprises:
(a) conditioning at least one active ingredient by adding it to a solvent and heating the temperature of more than about 30° C.;
(b) admixing the organic compound with said active ingredient of step (a) to obtain a homogeneous mixture; and
(c) cooling the homogeneous mixture to room temperature to obtain the agrochemical composition.

According to an embodiment of the present invention, a process for the preparation of an agrochemical composition; wherein said process comprises:
(a) conditioning at least one active ingredient by adding it to a solvent and heating the temperature of more than about 30° C.;
(b) optionally adding at least one agrochemically acceptable excipient to obtain a conditioned blend;
(c) admixing an organic compound with said conditioned blend of step (b) to obtain a homogeneous mixture; and
(d) cooling the homogeneous mixture to room temperature to obtain the agrochemical composition.

According to an embodiment of the present invention, conditioning of the active ingredient is by way of mixing it with a solvent followed by dissolution of said active ingredient.

According to an embodiment of the present invention, conditioning of the active ingredient is by way of mixing it with a solvent followed by dispersion of said active ingredient.

According to an embodiment of the present invention, the solvent used for conditioning the active ingredient is immiscible in the organic compound comprising the long aliphatic alkyl chain.

According to an embodiment of the present invention, the solvent used for conditioning the active ingredient is miscible in the organic compound comprising the long aliphatic alkyl chain.

According to an embodiment of the present invention, the solid-state active ingredient is first dissolved in a solvent and heated at a temperature of more than about 30° C. and then mixed with an organic compound comprising a long aliphatic alkyl chain.

According to an embodiment of the present invention, the solid-state active ingredient is first dispersed in a solvent and heated at a temperature of more than about 30° C. and then mixed with an organic compound comprising a long aliphatic alkyl chain.

According to an embodiment of the present invention, the liquid-state active ingredient and the organic compound are mixed at a temperature of more than about 30° C.

According to an embodiment of the present invention, the liquid-state active ingredient and the organic compound are mixed at a temperature from about 40° C. to about 90° C.

In an embodiment, the order of addition and mixing of the agrochemical ingredients and/or excipients is not narrowly critical.

According to an embodiment, there is provided use of the agrochemical composition as an insecticide for controlling pests, the composition comprising at least one insecticide active ingredient, an aromatic hydrocarbon solvent, and an organic compound comprising a long aliphatic alkyl chain encapsulating the active ingredient.

According to an embodiment, there is provided use of the agrochemical composition as a herbicide for controlling weeds, the composition comprising at least one herbicide active ingredient, an aromatic hydrocarbon solvent, and an organic compound comprising a long aliphatic alkyl chain encapsulating the active ingredient.

According to an embodiment, there is provided use of the agrochemical composition as a fungicide for controlling phytopathogenic fungal diseases, the composition comprising at least one fungicide active ingredient, an aromatic hydrocarbon solvent, and an organic compound comprising a long aliphatic alkyl chain encapsulating the active ingredient.

According to an embodiment of the present invention, a method of controlling pests comprises applying to the pests or locus thereof, an agrochemical composition comprising at least one active ingredient; and an organic compound comprising a long aliphatic alkyl chain encapsulating said active ingredient.

According to an embodiment of the present invention, a method of controlling pests comprises applying to the pests or locus thereof, an agrochemical composition comprising at least one active ingredient; and an organic compound comprising a long aliphatic alkyl chain encapsulating said active ingredient; wherein said active ingredient is conditioned by heating it to a temperature more than about 30° C.

According to an embodiment of the present invention, a method of controlling pests comprises applying to the pests or locus thereof, an agrochemical composition comprising at least one insecticide; and carnauba wax encapsulating said insecticide; wherein said insecticide is conditioned by heating it to a temperature more than about 30° C.

According to an embodiment of the present invention, a method of controlling weeds comprises applying to weeds or locus thereof, an agrochemical composition comprising at least one active ingredient; and an organic compound comprising a long aliphatic alkyl chain encapsulating said active ingredient; wherein said active ingredient is conditioned by heating it to a temperature more than about 30° C.

According to an embodiment of the present invention, a method of controlling weeds comprises applying to the weeds or locus thereof, an agrochemical composition comprising at least one herbicide; and carnauba wax encapsulating the herbicide; wherein said active ingredient is conditioned by heating it to a temperature more than about 30° C.

According to an embodiment of the present invention, a method of controlling phytopathogenic fungal diseases comprises applying to plants or locus thereof, an agrochemical composition comprising at least one active ingredient; and an organic compound comprising a long aliphatic alkyl chain encapsulating said active ingredient; wherein said active ingredient is conditioned by heating it to a temperature of more than about 30° C.

According to an embodiment of the present invention, a method of controlling phytopathogenic fungal diseases comprises applying to plants or locus thereof, an agrochemical composition comprising at least one fungicide; and carnauba wax encapsulating the fungicide; wherein said active ingredient is conditioned by heating it to a temperature of more than about 30° C.

In a preferred embodiment, the agrochemical composition is applied in a range of about 1 g a.i/ha to about 5000 g a.i/ha.

According to an embodiment, it was found that about 80% lambda-cyhalothrin was released in 30 minutes and then remaining 20% release was released in 60 minutes.

According to an embodiment of the present disclosure, the agrochemical composition of the present disclosure is stable, over time and at various temperatures.

In an embodiment of the present disclosure, the agrochemical composition preferably retains its physical integrity during handling and spreading,

According to an embodiment of the present invention, a kit of parts comprising an agrochemical composition is provided. The kit comprises a plurality of components, each of which components may include at least one or more of the ingredients of the agrochemical composition of the present invention.

According to an embodiment of the present invention, a kit of parts comprises: at least one active ingredient; and an organic compound comprising a long aliphatic alkyl chain encapsulating the active ingredient.

According to an embodiment of the present invention, a kit of parts comprises: at least one active ingredient;
an aromatic hydrocarbon solvent; and
an organic compound comprising a long aliphatic alkyl chain encapsulating the active ingredient.

According to an embodiment of the present invention, a kit of parts comprises: at least one conditioned active ingredient;
an aromatic hydrocarbon solvent; and
an organic compound comprising a long aliphatic alkyl chain encapsulating the active ingredient.

According to an embodiment of the present invention, a kit of parts comprises:
lambda-cyhalothrin;
an aromatic hydrocarbon solvent; and
carnauba wax encapsulating lambda-cyhalothrin.

According to an embodiment of the present invention, a kit of parts comprises:
bifenthrin;
an aromatic hydrocarbon solvent; and
carnauba wax encapsulating bifenthrin.

According to an embodiment of the present invention, a kit of parts comprises:
at least one active ingredient;
an organic compound comprising a long aliphatic alkyl chain encapsulating the active ingredient; and
optionally further comprises instructions for use.

According to an embodiment of the present invention, a kit of parts comprises: at least one active ingredient;
an aromatic hydrocarbon solvent;
an organic compound comprising a long aliphatic alkyl chain encapsulating the active ingredient; and
optionally further comprises instructions for use.

In one embodiment of the present invention, the kits may include one or more, including all, components that may be used to prepare the agrochemical composition. E.g., kits may include an active ingredient, an aromatic hydrocarbon solvent, and an organic compound. One or more of the components may already be combined or pre-formulated. In those embodiments where more than two components are provided in a kit, the components may already be combined and as such are packaged in a single container such as a vial, bottle, can, pouch, bag or canister.

In view of the above, it will be seen that the several advantages of the disclosure are achieved, and other advantageous results attained. Although the present disclosure has been disclosed in full, it will be understood that numerous additional modifications and variations could be made thereto without departing from the scope of the disclosure. The embodiments may be combined together for better understanding of the disclosure, without departing from the scope of the disclosure.

While the invention will now be described in connection with certain preferred embodiments in the following examples, it will be understood that it is not intended to limit the invention to these particular embodiments. On the contrary, it is intended to cover all alternatives, modifications and equivalents as may be included within the scope of the invention as defined by the appended claims. Thus, the following examples, which include preferred embodiments, will serve to illustrate the practice of this invention, it being understood that the particulars shown are by way of example and for purposes of illustrative discussion of preferred embodiments of the present invention only and are presented in the cause of providing what is believed to be the most useful and readily understood description of procedures as well as of the principles and conceptual aspects of the invention.

### EXAMPLES

### Example 1: Lambda-Cyhalothrin 25% w/w Capsule Suspension (CS)

| Ingredients | Quantity (% w/w) |
|---|---|
| Lambda-cyhalothrin | 24.23 |
| aromatic hydrocarbon solvent | 10.00 |
| Carnauba wax | 04.00 |
| Ethoxylated cetostearyl alcohol | 15.60 |
| Water | Q.S. |
| Total | 100.00 |

### Process:

24.23 parts lambda-cyhalothrin was dissolved in 10 parts aromatic hydrocarbon solvent and heated at about 60° C. to 90° C. in vessel-1. 4 parts of carnauba wax was then added to the vessel-1 under gentle stirring. Separately, 15.6 parts ethoxylated cetostearyl alcohol and water were mixed in vessel-2 to obtain a blend. The blend of vessel-2 was added to vessel-1 and homogenized to obtain a homogeneous mixture. The homogeneous mixture thus obtained was allowed to cool down to room temperature to obtain an encapsulated agrochemical composition as a capsule suspension.

### Example 2: Lambda-Cyhalothrin 10% w/w Capsule Suspension (CS)

| Ingredients | Quantity (% w/w) |
|---|---|
| Lambda-cyhalothrin | 10.00 |
| aromatic hydrocarbon solvent | 4.00 |
| Carnauba wax | 0.10 |
| Ethoxylated cetostearyl alcohols | 14.55 |
| Water | Q.S. |
| Total | 100.00 |

### Process:

Lambda-cyhalothrin, aromatic hydrocarbon solvent, carnauba wax, ethoxylated cetostearyl alcohol, and water were mixed and processed according to the process described in Example 1 to obtain an encapsulated agrochemical composition as a capsule suspension.

### Example 3: Lambda-Cyhalothrin 50% w/w Dry Powder

| Ingredients | Quantity (% w/w) |
|---|---|
| Lambda-cyhalothrin | 50.00 |
| Wax (Carnauba) | 50.00 |
| Total | 100.00 |

### Process:

50 parts of lambda-cyhalothrin was added in a vessel with heating and cooling facility. The vessel was kept on low flame to heat lambda-cyhalothrin at a temperature of about 80-85° C. and was mixed well to obtain conditioned lambda-cyhalothrin. To the conditioned lambda-cyhalothrin, 50 parts carnauba wax was added and mixed gently to obtain a homogeneous mixture. The resulting homogeneous mixture was then allowed to cool down to room temperature to obtain the encapsulated agrochemical composition.

### Example 4: Bifenthrin 50% w/w Dry Powder

| Ingredients | Quantity (% w/w) |
|---|---|
| Bifenthrin | 50.00 |
| Wax (Carnauba) | 50.00 |
| Total | 100.00 |

### Process:

50 parts of bifenthrin was added in a vessel with heating and cooling facility. The vessel was kept on low flame to heat bifenthrin at a temperature of about 80-85° C. and was mixed well to obtain conditioned bifenthrin. To the conditioned bifenthrin, 50 parts carnauba wax was added and mixed gently to obtain a homogeneous mixture. The resulting homogeneous mixture was then allowed to cool down to the room temperature to obtain the encapsulated agrochemical composition.

### Example 5: Bifenthrin 10% w/w Emulsifiable Concentrate (EC)

| Ingredients | Quantity (% w/w) |
|---|---|
| Bifenthrin | 10.00 |
| Carnauba wax | 0.20 |
| Aromatic hydrocarbon solvent | 81.80 |
| Ethoxylated cetostearyl alcohol | 8.00 |
| Total | 100.00 |

### Process:

10 parts bifenthrin was dissolved in 50 parts aromatic hydrocarbon solvent and heated to a temperature of about 60-90° C. Then, 0.20 parts of carnauba wax was added to the same vessel. Thereafter, 8 parts of emulsifier was added and mixed well. Then the remaining 31.80 parts of aromatic hydrocarbon solvent was added and mixed well to obtain a homogenous mixture. The homogeneous mixture thus obtained was allowed to cool down to room temperature to obtain encapsulated agrochemical composition in the form of an emulsifiable concentrate (EC).

### Example 6: Stability Study of the Composition of Example 1

Various physico-chemical parameters of the composition of Example 1 were studied for evaluating the stability profile of the agrochemical composition prepared according to the process described in the present invention. The parameters were studied both on 0 days at ambient conditions and when the sample was subjected to accelerated heat stability (AHS) kept at 54° C. for 2 weeks. The appearance of the composition obtained remained as such, without any noticeable change upon visual inspection. The active content remained almost constant in an acceptable range. The suspensibility was found to be more than 85% in both ambient as well as in AHS study. The pH of the composition was found to be stable with slight variation within the acceptable limit. The composition passed the wet sieve test with zero retention on the 200 British standard sieve (BSS) sieve. The changed viscosity of the composition was found to be within the acceptable range. Persistent foam was not observed in ambient nor in AHS conditions. A special observation was made on the particle size of the composition and the product remained quite stable with D₅₀ from about 6 μm to about 7 μm and D₉₀ from about 13 μm to about 14 μm. (Table 1)

TABLE 1
Stability study of Example 1

| | | Example 1 | |
|---|---|---|---|
| Sr. No. | Parameters | Ambient | 14 Days AHS |
| 1 | Appearances | White color liquid | No separation, |
| | | suspension | no sediment |
| 2 | Active content (% w/w) | 24.62 | 24.52 |
| 3 | Suspensibility | 96.29 | 87.64 |
| 4 | 1% pH aqueous | 6.68 | 6.52 |
| | suspension | | |
| 5 | Wet Sieve test (retention) | Nil | Nil |
| | 200 BSS | | |
| 7 | Viscosity (at | 425 centipoise (cP) | 732 cP |
| | 60 rpm, spindle 2) | | |
| 8 | Persistent Foam | Nil | Nil |
| | Particle Size (μm) capsule size | | |
| 9 | D₅₀ | 6.05 | 6.53 |
| | D₉₀ | 13.7 | 13.4 |
| | D₉₈ | 18.6 | 18.1 |

### Example 7: Release Rate Study

The composition of Example 1 developed according to the present invention was studied to find the release rate of lambda-cyhalothrin by the Collaborative International Pesticides Analytical Council (CIPAC) Miscellaneous Techniques (MT) 190. The sample was withdrawn from the apparatus at various points in time i.e., 5 minutes, 15 minutes, 30 minutes and 60 minutes and the amount of lambda-cyhalothrin was analysed. It was found that about 80% lambda-cyhalothrin was released in 30 minutes and then remaining 20% (making it complete 100%) was released in 60 minutes. Therefore, the agrochemical composition developed according to the present invention successfully demonstrated a controlled release of the active ingredients under the influence of an encapsulating agent. (Table 2)

TABLE 2
Release Rate Study

| | Time | Rate of |
|---|---|---|
| Sr. No. | Interval | release (%) |
| 1 | 5 minutes | 6.0 |
| 2 | 15 minutes | 24.3 |
| 3 | 30 minutes | 81.8 |
| 4 | 60 minutes | 100.0 |

The agrochemical composition comprising at least one active ingredient; and an encapsulating agent selected from an organic compound comprising long aliphatic alkyl chain developed according to the present invention resulted into stable compositions. The encapsulating agent successfully encapsulated the active ingredient by providing a coat and facilitated controlled release of the active ingredient. The advantage of the composition and the process of preparation lies in its versatility to be able to encapsulate various types of active ingredients and to support development of various formulation types.

### Example 8: Toxicity Study

Composition of Example 1 was taken for toxicity assessment. The assessment was done as per the Globally Harmonized System of classification and labelling of chemicals (GHS), 2021. The result of these studies has been disclosed in Table 3. As evident from Table 3, the composition of the present invention has low levels of toxicity. The composition of the present invention is not classified either as an eye irritant or as a skin irritant as per the Organization for Economic Cooperation and Development (OECD) GHS 2021 classification, further confirming the low toxicity of the composition. It may be noted that being an agrochemical composition, the most critical parameters of toxicity, from the point of view of an user, are acute dermal and acute eye irritation. As evident from Table 3, for all these parameters, the composition of the present invention was classified as safe.

TABLE 3
Toxicity Study
Mammalian toxicity studies of Lambda-Cyhalothrin 250 g/L (CS)

| Test | Toxicity category (OECD GHS 2021) |
|---|---|
| Acute Dermal Irritation | Not classified as a skin irritant |
| Acute Eye Irritation | Not classified as an eye irritant |

The inventors of the present invention successfully developed agrochemical compositions of an active ingredient and an organic compound comprising long aliphatic alkyl chain encapsulating said active ingredient by conditioning the active ingredient by heating it to a temperature of more than about 30° C., which is sufficient to surpass the softening point of the organic compound comprising long aliphatic alkyl chain. The agrochemical compositions formulated in various solid and liquid compositions demonstrated excellent physico-chemical profile.

### Example 9: Lambda-Cyhalothrin 250 g/L Capsule Suspension (CS)

| Ingredients | Quantity (% w/w) |
|---|---|
| Lambda-cyhalothrin | 24.47 |
| Aromatic hydrocarbon solvent | 10.00 |
| Carnauba wax | 06.00 |
| Propylene glycol | 05.00 |
| Cetostearyl Alcohol Ethoxylate | 09.00 |
| Xanthan gum | 04.00 |
| Water | Q.S. |
| Total | 100.00 |

### Process

The composition is prepared following the process as per Example 1.

### Example 10: Lambda-Cyhalothrin 250 g/L Capsule Suspension (CS)-Comparative Example

| Ingredients | Quantity (% w/w) |
|---|---|
| Lambda-cyhalothrin Technical 23.5@ 95 | 24.74 |
| Aromatic hydrocarbon solvent | 15.00 |
| Isocyanate | 0.5 |
| Sodium Lignosulphonate | 5.00 |
| Ethylene oxide and propylene | 2.50 |
| oxide copolymer | |
| Propylene glycol | 07.00 |
| Amine component | 0.3 |
| Hydrochloric acid | 0.52 |
| Xanthan gum | 10.00 |
| Water | Q.S. |
| Total | 100.00 |

### Determination of Surface Tension Using Pendant Drop Method in Pesticide Formulation:

A sample of composition prepared according to Example 9 was subjected to surface tension measurements. The tests were performed optically using Surface Tensiometer using pendant drop shape analysis. 0.1 g of Sample was taken in 100 ml volumetric flask and made up with distilled water and sonicated for 2 minutes. A syringe was filled with the sample and created a drop of about 6 μl to about 7 μl and measured surface tension. For comparison, the study was conducted on water sample as well as a market sample of polyurea encapsulated Lambda-cyhalothrin formulation. The results obtained are disclosed in Table 4.

### Determination of Contact Angle by Using Pendant Drop Method in Pesticide Formulation:

A sample of composition prepared according to Example 9 was subjected to contact angle measurements. The tests were performed using a Surface Tensiometer. 0.1 g of sample was taken in 100 ml volumetric flask and made up with distilled water and sonicated for 2 minutes. A syringe was filled with the sample and created a drop of about 6 μl to about 7 μl. The drops were dispensed on parafilm surface and measured the contact angles. For comparison, the study was conducted on water sample as well as a sample of polyurea encapsulated Lambda-cyhalothrin formulation (Example 10). The results obtained are disclosed in Table 4.

TABLE 4
Surface tension and contact angle of composition
according to Example 9 and Example 10
Lambda CS

| | Surface Tension (N/m) | | | Contact Angle | | |
|---|---|---|---|---|---|---|
| Time | Water- | Example | Example | Water - | Example | Example |
| (ms) | ST | 9 | 10 | CA | 9 | 10 |
| 1000 | 72.6 | 55.16 | 68.80 | 105.2° | 80.45° | 94.80° |
| 2000 | 72.6 | 54.80 | 66.20 | 105.2° | 80.88° | 94.80° |
| 3000 | 72.6 | 54.06 | 67.80 | 105.2° | 79.85° | 94.60° |
| 4000 | 73.9 | 52.10 | 67.32 | 105.2° | 79.28° | 94.50° |
| 5000 | 72.6 | 51.04 | 67.72 | 105.2° | 78.35° | 94.50° |
| 6000 | 72.6 | 50.70 | 67.24 | 105.2° | 78.10° | 94.50° |
| 7000 | 73.9 | 48.26 | 67.24 | 105.2 | 77.78 | 94.50 |
| 8000 | 73.9 | 48.62 | 65.22 | 105.2 | 77.48 | 94.50 |
| 9000 | 72.6 | 47.22 | 66.16 | 105.0 | 76.78 | 94.50 |
| 10000 | 72.6 | 45.58 | 66.64 | 105.0 | 76.90 | 94.50 |

It was observed that the surface tension of Example 9 was present in a range from about 40 N/m to about 60 N/m. Also, the contact angle of Example 9 was present in a range from about 70° to about 85°.

### Example 11: Cypermethrin 350 g/L Capsule Suspension (CS)

| Ingredients | Quantity (% w/w) |
|---|---|
| Cypermethrin | 35.37 |
| Aromatic hydrocarbon solvent | 5.00 |
| Calcium salt of Alkyl Benzene Sulfonate | 1.20 |
| Tristyryphenol ethoxylate | 3.6 |
| Carnauba Wax | 6.00 |
| Propylene glycol | 5.00 |
| Ethoxylated cetostearyl alcohols | 4.50 |
| Xanthan Gum | 4.00 |
| Water | Q.S. |
| Total | 100.00 |

### Process

Required quantities of Cypermethrin, aromatic hydrocarbon solvent, calcium salt of alkyl benzene sulfonate, tristyryphenol ethoxylate and carnauba wax were mixed 10 in a vessel and heated up to 60° C. to 70° C. to obtain a homogeneous liquid (Mixture 1). Separately, water, propylene glycol, Ethoxylated cetostearyl alcohol and xanthan gum were mixed in a vessel and heated up to 60° C. to 70° C. to obtain homogeneous solution (Mixture 2). The homogenized mixtures 1 and 2 were mixed to get an emulsion and was cooled to room temperature. Finally, the resulting composition was structured to obtain an encapsulated agrochemical composition as a capsule suspension.

### Example 12: Stability Study Data for Composition of Example 11

The stability study for the composition of Example 11 has been disclosed in Table 5.

TABLE 5
Stability study for Example 11

| | | | 14 Days AHS | 7 Cycle |
|---|---|---|---|---|
| Sr. No. | Parameters | Ambient | 54° C. | freeze thaw |
| 1 | Appearances | White color | No separation, | No separation, |
| | | liquid | No sedimentation | No sedimentation |
| | | flowable | flowable | flowable |
| | | suspension | liquid | liquid |
| 2 | Active content | 360.23 | 360.34 | 357.76 |
| | in g/L | | | |
| 3 | pH (1% | 6.20 | 6.18 | 6.02 |
| | Solution) | | | |
| 4 | Persistence | 5 | Nil | 2 |
| | foam after 1 | | | |
| | minute in mL | | | |
| 5 | Wet sieve | Nil | Nil | Nil |
| | retention on | | | |
| | 75 Micron | | | |
| 6 | Viscosity Sp 2, | 968 | 932 | 900 |
| | 30 rpm (cP) | | | |
| 7 | Spontaneity of | 100 | 98.7 | — |
| | Dispersion | | | |
| | (% w/w) | | | |
| 8 | Suspensibility | 98.3 | 96.3 | 97.6 |
| | (% w/w) | | | |
| 9 | Particle | 0.846 | 0.802 | 0.825 |
| | size D₁₀ | | | |
| | D₅₀ | 1.64 | 1.60 | 1.62 |
| | D₉₈ | 4.46 | 4.43 | 4.80 |
| | Dₘₑₐₙ | 1.85 | 1.80 | 1.86 |

### Example 13: Surface Tension and Contact Angle of Composition According to Example 11

The stability study for the composition of Example 11 has been disclosed in Table 6.

TABLE 6
Surface tension and contact angle for Example 11

| | Surface tension (N/m) | | Contact Angle | |
|---|---|---|---|---|
| Time (ms) | Water | Example 11 | Water-CA | Example 11 |
| 1000 | 72.6 | 50.92 | 105.2° | 79.75° |
| 2000 | 72.6 | 51.8 | 105.2° | 78.65° |
| 3000 | 72.6 | 48.48 | 105.2° | 78.55° |
| 4000 | 73.9 | 47.14 | 105.2° | 78° |
| 5000 | 72.6 | 45.84 | 105.2° | 77.1° |
| 6000 | 72.6 | 45.24 | 105.2° | 76.15° |
| 7000 | 73.9 | 45.39 | 105.2° | 76.25° |
| 8000 | 73.9 | 43.72 | 105.2° | 76.3° |
| 9000 | 72.6 | 46.09 | 105° | 75.35° |
| 10000 | 72.6 | 44.04 | 105° | 75.2° |

It was observed that the surface tension of Example 11 was present in a range from about 40 N/m to about 60 N/m. Also, the contact angle of Example 9 was present in a range from about 70° to about 85°.

### Example 14: Bio-Efficacy of the Inventive Formulations

In the following example, tests were conducted to evaluate the comparative insecticidal effectiveness of the formulations.

Objective: To check the efficacy of Lambda-cyhalothrin formulation against Chilli thrips.

### Experimental Details

Product: Lambda cyhalothrin 250 CS
Target Pest: Thrips
Recommended Dose: Lambda-cyhalothrin at 25 g a.i/h
Treatments & Dose
T1: Lambda-cyhalothrin 250 CS-Composition as per Example 9 (Sample 1) @ half field dose
T2: Lambda-cyhalothrin 250 CS-Composition as per Example 10 (Sample 2) @ half field dose
T3: Control

### Methodology & Observations

1. Prepared 1% agar solution and poured in the petri plates.
2. Collected sufficient non-infested, untreated Chilli plant leaves.
3. The stock solution of the selected insecticides was prepared in distilled water. Further desired concentration was prepared by dilution of the stock solution using appropriate quantity. Field doses of the respective insecticides were taken into consideration. Half and ¼th concentrations were prepared and used for bioassay.
4. Leaf discs of 30 mm diameter were cut using sharp cylindrical metal ring and the discs were less in diameter compared to the petri plate.
5. Leaf discs were dipped into a respective test solution for about 10 seconds and then air dried.
6. Treatment details were recorded on each petri plate and each treated leaf disc was placed over solidified agar gel.
7. 10 nymphs were transferred into each of the leaf discs using the paint brush, each unit was sealed with a close-fitting, ventilated lid.
8. Stored the containers in an area where they are not exposed to direct sunlight or extremes of temperature.

An assessment of mortality (dead and live thrips) was made after 24 hrs. (Table 7) Calculations: Percentage mortality and corrected percentage mortality were calculated using Schneider-Orelli's formula

$$\% mortality = \frac{No . of dead thrips after 24 hrs}{2 a Total number of thrips released on Day 0 \times 100} \\ Corrected \% mortality = \frac{( \% mortality in Test - \% mortaliy in Control )}{( 100 - \% mortality in Control ) \times 100}$$

TABLE 7
Mortality assessment of dead and live thrips

| | | Mean No. of | Mean No. of | | |
|---|---|---|---|---|---|
| | | thrips released | Dead thrips | % | Corrected % |
| Sr. No. | Treatment | per plate | after 24 hrs | mortality | mortality |
| T1 | Sample 1 | 10 | 5.75 | 57.5 | 51.43 |
| T2 | Sample 2 | 10 | 4.0 | 40 | 31.43 |
| T3 | Control | 10 | 1.25 | 12.5 | — |

From the above results, it has been observed that the composition of Lambda-cyhalothrin at half the recommended dose showed higher efficacy in terms of mortality than a conventional polyurea encapsulated product.

1. An agrochemical composition comprising:
at least one active ingredient; and
an organic compound comprising a long aliphatic alkyl chain encapsulating said active ingredient, wherein said active ingredient is conditioned by heating it to a temperature at or more than about 30° C.

2. (canceled)

3. (canceled)

4. The composition as claimed in claim 1, wherein said active ingredient is selected from the group consisting of an insecticide, a herbicide, a fungicide, biological agents, biostimulants, and combinations thereof.

5. The composition as claimed in claim 4, wherein said insecticide is selected from the group consisting of acephate, cypermethrin, bifenthrin, lambda-cyhalothrin, cyhalothrin, buprofezin, carbofuran, cartap, chlorfenapyr, chlorpyrifos, dimethoate, malathion, imidacloprid, acetamiprid, clothianidin, monocrotophos, nitenpyram, pirimiphos, propoxur, thiodicarb, trichlorphon, chlorantraniliprole, cyantraniliprole, their derivatives, and mixtures thereof.

6. The composition as claimed in claim 4, wherein said herbicide is selected from the group consisting of 2,4-D, bensulfuron-methyl, bentazone, butachlor, carfentrazone, amicarbazone, sulfentrazone, cyhalofop-butyl, haloxyfop-p-methyl, clodinafop-propargyl, clethodim, propanil, imazosulfuron, 2-methyl-4-chlorophenoxyacetic acid, mefenacet, napropamide, glufosinate, clomazone, oxadiazon, pendimethalin, pretilachlor, pyrazosulfuron-ethyl, metsulfuron, their derivatives, and mixtures thereof.

7. The composition as claimed in claim 4, wherein said fungicide is selected from the group consisting of boscalid, tebuconazole, azoxystrobin, fluoxastrobin, prothioconazole, cyproconazole, trifloxystrobin, captan, folpet, kasugamycin, metalaxyl, thiophanate-methyl, tricyclazole, triflumizole, and validamycin, copper fungicides, mancozeb, mancopper, zineb, fluindapyr, bixafen, fluxapyroxad, their derivatives, and mixtures thereof.

8. The composition as claimed in claim 4, wherein said biological agents and biostimulants are selected from the group consisting of seaweed extract, laminarin, essential oils, superabsorbent polymers, ortho-silicic acid, ancymidol, butralin, alcohols, chlormequat chloride, cytokinin, daminozide, ethephon, ethylene, humic acid, fulvic acid, flurprimidol, gibberellic acid, gibberellin mixtures, indole-3-butyric acid, maleic hydrazide, potassium salt, mefluidide, mepiquat chloride, mepiquat pentaborate, naphthalene-acetic acid, 1-naphthaleneacetamide, n-decanol, paclobutrazol, prohexadione calcium, trinexapac-ethyl, uniconazole, and combinations thereof.

9. The composition as claimed in claim 1, wherein said composition comprises from about 0.1% w/w to about 99% w/w active ingredient based on a total weight of the composition.

10. The composition as claimed in claim 1, wherein said organic compound comprising long aliphatic alkyl chain comprises mixtures of substituted long-chain aliphatic hydrocarbons, comprising alkanes, alkyl esters, fatty acids, primary and secondary alcohols, diols, ketones, aldehydes, and combinations thereof.

11. The composition as claimed in claim 1, wherein said organic compound comprising long aliphatic alkyl chain comprises plant wax, wherein the plant wax is selected from the group consisting of cotton wax, carnauba wax, rice bran wax, candelilla wax, Japan wax, sugarcane wax, and combinations thereof.

12. The composition as claimed in claim 1, wherein said composition comprises from about 0.1% w/w to about 99% w/w organic compound based on a total weight of the composition.

13. The composition as claimed in claim 1, wherein the composition is in a form comprising water dispersible granules (WDG or WG), capsule suspension (CS), suspension concentrate (SC), emulsion, microemulsion (ME), emulsifiable concentrate (EC), oil dispersion (OD), wettable powder (WP), granules (GR), extended-release granules, sustained release granules, delayed release granules, controlled release granules, ZC (mixed formulation of CS and SC), dry powder, and combinations thereof.

14. An agrochemical composition comprising:
at least one active ingredient;
at least one non-aqueous solvent; and
an organic compound comprising a long aliphatic alkyl chain encapsulating said at least one active ingredient;
wherein said at least one active ingredient is conditioned by heating the at least one active ingredient in the non-aqueous solvent to a temperature more than a softening point of said organic compound.

15. The composition as claimed in claim 14, wherein said non-aqueous solvent is selected from the group consisting of aromatic hydrocarbons, aliphatic hydrocarbons, alcohols, ketones, esters, ether, amides, their derivatives, and mixtures thereof.

16. A process for preparing an agrochemical composition, the process comprising:
(a) conditioning an active ingredient by heating said active ingredient to a temperature at or more than about 30° C.;
(b) admixing an organic compound comprising a long aliphatic alkyl chain with said active ingredient of step (a) to obtain a homogeneous mixture; and
(c) cooling the homogeneous mixture to room temperature to obtain said agrochemical composition, wherein the conditioning comprises heating it to a temperature more than softening point of said organic compound.

17. (canceled)

18. The process as claimed in claim 16, wherein said temperature ranges from about 40° C. to about 140° C.

19. A process for preparing an agrochemical composition, the process comprising:
(a) conditioning an active ingredient by adding the active ingredient to a solvent and heating the active ingredient at a temperature at or more than about 30° C.;
(b) admixing an organic compound comprising a long aliphatic alkyl chain with said active ingredient of step (a) to obtain a homogeneous mixture; and
(c) cooling the homogeneous mixture to room temperature to obtain the agrochemical composition.

20. The process as claimed in claim 19, wherein said solvent is selected from the group consisting of aromatic hydrocarbons, aliphatic hydrocarbons, alcohols, ketones, esters, ether, amides, their derivatives, and mixtures thereof.

21. A method of controlling pests comprises applying to the pests or a locus thereof, an agrochemical composition comprising at least one active ingredient; and an organic compound comprising a long aliphatic alkyl chain encapsulating said at least one active ingredient.

22. (canceled)
